(19) United States
(12) Patent Application Publication
(10) Pub. No.: US 2020/0254928 A1
(43) Pub. Date: Aug. 13, 2020

(54) SYSTEM AND METHOD TO INDICATE THE SPACE AVAILABLE TO OPEN A CAR DOOR

(71) Applicant: GM GLOBAL TECHNOLOGY OPERATIONS LLC, DETROIT, MI (US)

(72) Inventors: Sean S. Monteiro, Alberta (CA); Fahim Javid, Ontario (CA); David A. Canella, Ontario (CA); Remi Guertin, Ontario (CA)

(21) Appl. No.: 16/271,270

(22) Filed: Feb. 8, 2019

(51) Int. Cl. B60Q 9/00; E05F 15/40

(52) U.S. Cl. CPC B60Q 9/008; B60J 5/04; E05F 15/40

(57) ABSTRACT

One general aspect includes a method to indicate the space available to open a vehicle door, the method including: sensing, via a processor, a horizontal distance between the vehicle door and an object in an environment surrounding a vehicle; determining, via the processor, if the horizontal distance is greater than or less than a first threshold value; determining, via the processor, if the horizontal distance is greater than or less than a second threshold value; and providing, via the processor, an indicator based on the determination of whether the horizontal distance is greater than or less than the first threshold value and the determination of whether the horizontal distance is greater than or less than the second threshold value.

### INTRODUCTION

Parking and retrieving items from the rear cargo area is traditionally a “two putt” process. The first step entails the car being parked without the driver giving any thought or having any perception of the space required to utilize their vehicle. The second step entails the driver repositioning their vehicle after they've realized that they don't have the room to swing their door open and get out or that they can't open their liftgate to retrieve items from the vehicle's rear cargo area. This process can be very frustrating for vehicle drivers, especially when they are short on time. It can also lead to mistakes such as, for example, scratching or denting the vehicle's liftgate or side door against objects as well as damaging the liftgate's hydraulic opening system components due to resistance from such objects. It is therefore desirable to provide a system and method that enables a driver to park and retrieve items from the vehicle's cargo area in one step. It is also desirable for this system and method to provide this vehicle driver with insight as to the varying degrees of space available to swing open their door and/or liftgate so as to avoid vehicle harm. It is also desirable for this insight to come in the form of indicators being exhibited on the screen of an infotainment display, so the driver can grasp how much available space is in the area around their vehicle while they are parking. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method to indicate the space available to open a vehicle door, the method including: sensing, via a processor, a horizontal distance between the vehicle door and an object in an environment surrounding a vehicle; determining, via the processor, if the horizontal distance is greater than or less than a first threshold value; determining, via the processor, if the horizontal distance is greater than or less than a second threshold value; and providing, via the processor, an indicator based on the determination of whether the horizontal distance is greater than or less than the first threshold value and the determination of whether the horizontal distance is greater than or less than the second threshold value. Other embodiments of this aspect include corresponding computer systems, apparatus, and computer programs recorded on one or more computer storage devices, each configured to perform the actions of the methods.

Implementations may include one or more of the following features. The method where: the indicator can be provided as a low-risk indicator, medium-risk indicator, or high-risk indicator; where the high-risk indicator is provided when the processor determines that the horizontal distance is less than the first threshold value; where the medium-risk indicator is provided when the processor determines that the horizontal distance is greater than the first threshold value and less than the second threshold value; and where the low-risk indicator is provided when the processor determines that the horizontal distance is greater than the second threshold value. The method further including: disabling, via the processor, an automatic vehicle door opening function when the processor determines that the horizontal distance is less than the first threshold value. The method further including: sensing, via the processor, a vertical distance between the vehicle door and a surface in the environment surrounding the vehicle; determining, via the processor, if the vertical distance is greater than or less than a third threshold value; and disabling, via the processor, an automatic vehicle door opening function when the processor determines that the vertical distance is less than the third threshold value. The method where the indicator is provided by being exhibited on a display located in the vehicle. The method where the vehicle door is a liftgate and where the indicator is configured to provide a vehicle occupant with an understanding of an amount of space located between the liftgate and the object in the environment surrounding the vehicle. The method where the vehicle door is an occupant door and where the indicator is configured to provide a vehicle occupant with an understanding of an amount of space located between the occupant door and the object in the environment surrounding the vehicle. Implementations of the described techniques may include hardware, a method or process, or computer software on a computer-accessible medium.

One general aspect includes a system to indicate the space available to open a vehicle door, the system including: a memory configured to include one or more executable instructions and a processor configured to execute the executable instructions, where the executable instructions enable the processor to carry out the following steps: sensing a horizontal distance between the vehicle door and an object in an environment surrounding a vehicle; determining if the horizontal distance is greater than or less than a first threshold value; determining if the horizontal distance is greater than or less than a second threshold value; and providing an indicator based on the determination of whether the horizontal distance is greater than or less than the first threshold value and the determination of whether the horizontal distance is greater than or less than the second threshold value. Other embodiments of this aspect include corresponding computer systems, apparatus, and computer programs recorded on one or more computer storage devices, each configured to perform the actions of the methods.

Implementations may include one or more of the following features. The system where: the indicator can be provided as a low-risk indicator, medium-risk indicator, or high-risk indicator; where the high-risk indicator is provided when the processor determines that the horizontal distance is less than the first threshold value; where the medium-risk indicator is provided when the processor determines that the horizontal distance is greater than the first threshold value and less than the second threshold value; and where the low-risk indicator is provided when the processor determines that the horizontal distance is greater than the second threshold value. The system where the executable instructions enable the processor to carryout the following steps: disabling an automatic vehicle door opening function when the processor determines that the horizontal distance is less than the first threshold value. The system where the executable instructions enable the processor to carryout the following steps: sensing a vertical distance between the vehicle door and a surface in the environment surrounding the vehicle; determining if the vertical distance is greater than or less than a third threshold value; and disabling an automatic vehicle door opening function when the processor determines that the vertical distance is less than the third threshold value. The system where the indicator is provided by being exhibited on a display located in the vehicle. The system where the vehicle door is a liftgate and where the indicator is configured to provide a vehicle occupant with an understanding of an amount of space located between the liftgate and the object in the environment surrounding the vehicle. The system where the vehicle door is an occupant door and where the indicator is configured to provide a vehicle occupant with an understanding of an amount of space located between the occupant door and the object in the environment surrounding the vehicle. Implementations of the described techniques may include hardware, a method or process, or computer software on a computer-accessible medium.

One general aspect includes a non-transitory and machine-readable medium having stored thereon executable instructions adapted to indicate the space available to open a vehicle door, which when provided to a processor and executed thereby, causes the processor to carry out the following steps: sensing a horizontal distance between the vehicle door and an object in an environment surrounding a vehicle; determining if the horizontal distance is greater than or less than a first threshold value; determining if the horizontal distance is greater than or less than a second threshold value; and providing an indicator based on the determination of whether the horizontal distance is greater than or less than the first threshold value and the determination of whether the horizontal distance is greater than or less than the second threshold value. Other embodiments of this aspect include corresponding computer systems, apparatus, and computer programs recorded on one or more computer storage devices, each configured to perform the actions of the methods.

Implementations may include one or more of the following features. The non-transitory and machine-readable memory where: the indicator can be provided as a low-risk indicator, medium-risk indicator, or high-risk indicator; where the high-risk indicator is provided when the processor determines that the horizontal distance is less than the first threshold value; where the medium-risk indicator is provided when the processor determines that the horizontal distance is greater than the first threshold value and less than the second threshold value; and where the low-risk indicator is provided when the processor determines that the horizontal distance is greater than the second threshold value. The non-transitory and machine-readable memory where the executable instructions enable the processor to carryout an additional step of disabling an automatic vehicle door opening function when the processor determines that the horizontal distance is less than the first threshold value. The non-transitory and machine-readable memory where the executable instructions enable the processor to carryout the following additional steps: sensing a vertical distance between the vehicle door and a surface in the environment surrounding the vehicle; determining if the vertical distance is greater than or less than a third threshold value; and disabling an automatic vehicle door opening function when the processor determines that the vertical distance is less than the third threshold value. The non-transitory and machine-readable memory where the indicator is provided by being exhibited on a display located in the vehicle. The non-transitory and machine-readable memory where the vehicle door is a liftgate and where the indicator is configured to provide a vehicle occupant with an understanding of an amount of space located between the liftgate and the object in the environment surrounding the vehicle. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of an electronics system capable of utilizing the system and method disclosed herein;

FIG. 2 is an exemplary flow chart for the utilization of exemplary system and method aspects disclosed herein;

FIG. 3A is an illustrative aspect of the process flow of FIG. 2;

FIG. 3B is an illustrative aspect of the process flow of FIG. 2;

FIG. 3C is an illustrative aspect of the process flow of FIG. 2;

FIG. 4A is an illustrative aspect of the process flow of FIG. 2;

FIG. 4B is an illustrative aspect of the process flow of FIG. 2;

FIG. 4C is an illustrative aspect of the process flow of FIG. 2;

FIG. 5A is an illustrative aspect of the process flow of FIG. 2;

FIG. 5B is an illustrative aspect of the process flow of FIG. 2;

FIG. 5C is an illustrative aspect of the process flow of FIG. 2;

FIG. 6 is an exemplary flow chart for utilization of additional system and method aspects disclosed herein;

FIG. 7 is an additional exemplary flow chart for the utilization of alternative exemplary system and method aspects disclosed herein;

FIG. 8A is an illustrative aspect of the process flow of FIG. 7;

FIG. 8B is an illustrative aspect of the process flow of FIG. 7; and

FIG. 8C is an illustrative aspect of the process flow of FIG. 7.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

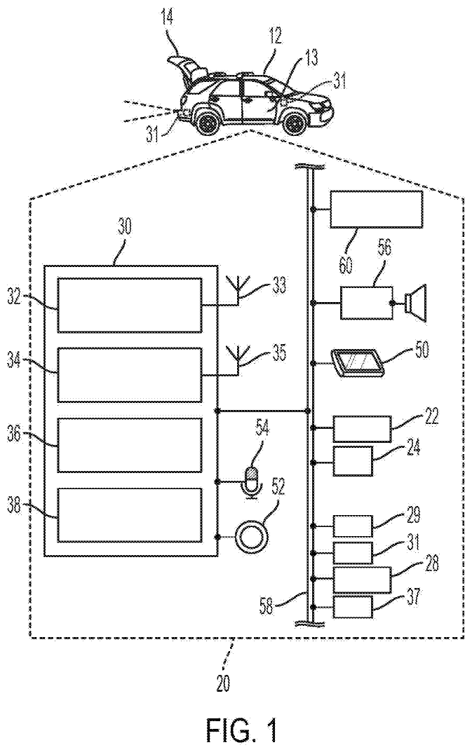

With reference to FIG. 1, vehicle 12 is depicted in the illustrated embodiment as a sports utility vehicle (SUV), but it should be appreciated that any other vehicle including motorcycles, trucks, passenger sedan, recreational vehicles (RVs), marine vessels, aircraft including unmanned aerial vehicles (UAVs), etc., can also be used. In certain embodiments, vehicle 12 may include a power train system with multiple generally known torque-generating devices including, for example, an engine. The engine may be an internal combustion engine that uses one or more cylinders to combust fuel, such as gasoline, in order to propel vehicle 12. The power train system may alternatively include numerous electric motors or traction motors that convert electrical energy into mechanical energy for propulsion of vehicle 12.

In one or more embodiments, the body of vehicle 12 can include multiple occupant doors 13, which are located on the side of vehicle 12 and allow a vehicle occupant ingress and egress from the vehicle cabin. The vehicle body can also include a liftgate 14 (i.e., a rear panel door that opens upward by, for example, hydraulics).

Some of the vehicle electronics 20 are shown generally, in FIG. 1 and includes a global navigation satellite system (GNSS) receiver 22, a body control module or unit (BCM) 24, and other vehicle system modules (VSMs) 28, a telematics unit 30, one or more proximity sensors 31, backup camera 37, vehicle-user interfaces 50-56, and onboard computer 60. Some or all of the different vehicle electronics may be connected for communication with each other via one or more communication busses, such as communications bus 58. The communications bus 58 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few. In other embodiments, a wireless communications network that uses short-range wireless communications (SRWC) to communicate with one or more VSMs of the vehicle can be used. In one embodiment, the vehicle 12 can use a combination of a hardwired communications bus 58 and SRWCs. The SRWCs can be carried out using the telematics unit 30, for example.

The vehicle 12 can include numerous vehicle system modules (VSMs) as part of vehicle electronics 20, such as the GNSS receiver 22, BCM 24, telematics unit 30 (vehicle communications system), vehicle-user interfaces 50-56, and onboard computer 60, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is hardwire connected by communications bus 58 to the other VSMs including the telematics unit 30. Moreover, each of the VSMs can include and/or be communicatively coupled to suitable hardware that enables intra-vehicle communications to be carried out over the communications bus 58; such hardware can include, for example, bus interface connectors and/or modems. One or more VSMs 28 may periodically or occasionally have their software or firmware updated and, in some embodiments, such vehicle updates may be over the air (OTA) updates that are received from a remote computer or facility via a land network (not shown) and telematics unit 30. As is appreciated by those skilled in the art, the above-mentioned VSMs are only examples of some of the modules that may be used in vehicle 12, as numerous others are also possible. It should also be appreciated that these VSMs can otherwise be known as electronic control units, or ECUs.

Global navigation satellite system (GNSS) receiver 22 receives radio signals from a constellation of GNSS satellites (not shown). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites (not shown). And, in another example, GNSS receiver 22 can be a BDS receiver that receives a plurality of GNSS (or BDS) signals from a constellation of GNSS (or BDS) satellites. The GNSS received can determine a current vehicle location based on reception of a plurality of GNSS signals from the constellation of GNSS satellites. The vehicle location information can then be communicated to the telematics unit 30, or other VSMs, such as the onboard computer 60. In one embodiment (as shown in FIG. 1), the wireless communications module 30 and/or a telematics unit can be integrated with the GNSS receiver 22 so that, for example, the GNSS receiver 22 and the telematics unit 30 (or the wireless communications device) are directly connected to one another as opposed to being connected via communications bus 58. In other embodiments, the GNSS receiver 22 is a separate, standalone module or there may be a GNSS receiver 22 integrated into the telematics unit 30 in addition to a separate, standalone GNSS receiver connected to telematics unit 30 via communications bus 58.

Body control module (BCM) 24 can be used to control various VSMs 28 of the vehicle, as well as obtain information concerning the VSMs, including their present state or status, as well as sensor information. The BCM 24 is shown in the exemplary embodiment of FIG. 1 as being electrically coupled to the communication bus 58. In some embodiments, the BCM 24 may be integrated with or part of a center stack module (CSM) and/or integrated with telematics unit 30 or the onboard computer 60. Or, the BCM may be a separate device that is connected to other VSMs via bus 58. The BCM 24 can include a processor and/or memory, which can be similar to processor 36 and memory 38 of telematics unit 30, as discussed below. The BCM 24 may communicate with wireless device 30 and/or one or more vehicle system modules, such as an engine control module (ECM), audio system 56, or other VSMs 28; in some embodiments, the BCM 24 can communicate with these modules via the communications bus 58. Software stored in the memory and executable by the processor enables the BCM to direct one or more vehicle functions or operations including, for example, controlling central locking, power windows 11, power sun/moon roof, the vehicle's head lamps 98, the horn system 99, air conditioning operations, power mirrors, controlling the vehicle primary mover (e.g., engine, primary propulsion system), and/or controlling various other vehicle modules. In one embodiment, the BCM 24 can be used (at least in part) to detect a vehicle event, such as a power on state or a power off state or when the vehicle's air conditioning operations are turned ON or OFF (i.e., cooled air is being blown or is stopped being blown from the vents of the vehicle's Heating Ventilation and Air Conditioning (HVAC) system), based on one or more onboard vehicle sensor readings, as discussed more below.

Telematics unit 30 is capable of communicating data via SRWC through use of SRWC circuit 32 and/or via cellular network communications through use of a cellular chipset 34, as depicted in the illustrated embodiment. The telematics unit 30 can provide an interface between various VSMs of the vehicle 12 and one or more devices external to the vehicle 12, such as one or more networks or systems at a remote call center (e.g., ON-STAR by GM). This enables the vehicle to communicate data or information with remote systems at a remote call center.

In at least one embodiment, the telematics unit 30 can also function as a central vehicle computer that can be used to carry out various vehicle tasks. In such embodiments, the telematics unit 30 can be integrated with the onboard computer 60 such that the onboard computer 60 and the telematics unit 30 are a single module. Or, the telematics unit 30 can be a separate central computer for the vehicle 12 in addition to the onboard computer 60. Also, the wireless communications device can be incorporated with or a part of other VSMs, such as a center stack module (CSM), body control module (BCM) 24, an infotainment module, a head unit, a telematics unit, and/or a gateway module. In some embodiments, the telematics unit 30 is a standalone module, and can be implemented as an OEM-installed (embedded) or aftermarket device that is installed in the vehicle.

In the illustrated embodiment, telematics unit 30 includes, the SRWC circuit 32, the cellular chipset 34, a processor 36, memory 38, SRWC antenna 33, and antenna 35. The telematics unit 30 can be configured to communicate wirelessly according to one or more SRWC protocols such as any of the Wi-Fi™, WiMAX™, Wi-Fi™ Direct, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. And, in some embodiments, the telematics unit 30 can be configured to communicate using IEEE 802.11p such that the vehicle can carry out vehicle-to-vehicle (V2V) communications, or vehicle-to-infrastructure (V2I) communications with infrastructure systems or devices, such as at a remote call center. And, in other embodiments, other protocols can be used for V2V or V2I communications.

The SRWC circuitry 32 enables the telematics unit 30 to transmit and receive SRWC signals, such as BLE signals. The SRWC circuit can allow the telematics unit 30 to connect to another SRWC device (e.g., a smart phone). Additionally, in some embodiments, the telematics unit 30 contains a cellular chipset 34 thereby allowing the device to communicate via one or more cellular protocols, such as those used by cellular carrier system 70, through antenna 35. In such a case, the telematics unit 30 is user equipment (UE) that can be used to in carry out cellular communications via cellular carrier system 70.

Antenna 35 is used for communications and is generally known to be located throughout vehicle 12 at one or more locations external to the telematics unit 30. Using antenna 35, telematics unit 30 may enable the vehicle 12 to be in communication with one or more local or remote networks (e.g., one or more networks at a remote call center or server) via packet-switched data communication. This packet switched data communication may be carried out through use of a non-vehicle wireless access point or cellular system that is connected to a land network via a router or modem. When used for packet-switched data communication such as TCP/IP, the communications device 30 can be configured with a static Internet Protocol (IP) address or can be set up to automatically receive an assigned IP address from another device on the network such as a router or from a network address server.

Packet-switched data communications may also be carried out via use of a cellular network that may be accessible by the telematics unit 30. Communications device 30 may, via cellular chipset 34, communicate data over wireless carrier system 70. In such a scenario, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the telematics unit 30 to provide a wide variety of services. For instance, in one embodiment, the processor 36 can execute programs or process data to carry out at least a part of the method discussed herein. Memory 38 may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. In one embodiment, the telematics unit 30 also includes a modem for communicating information over the communications bus 58.

Vehicle electronics 20 also includes one or more proximity sensors 31 and a backup camera 37. The proximity sensors 31 are electromagnetic or ultrasonic sensors positioned at various locations around the body of vehicle 12 (e.g., the front/rear bumper fascia, along one or more fenders, along one or more vehicle doors). Proximity sensors 31 measure the distances to nearby objects and can be used to alert the driver of obstacles while parking vehicle 12. For instance, sensors installed in the rear bumper fascia may be activated when the vehicle's reverse gear is selected and deactivated as soon as any other gear is selected (e.g., the drive gear). Moreover, as is generally known, when proximity sensor(s) 31 is embodied as an ultrasonic sensor, the device will rely on the reflection of sound waves to measure the distance from the vehicle's body to a nearby object.

Backup camera 37 is generally known to be a video camera attached to the rear of vehicle 12 so as to aid the vehicle operator in backing up their vehicle and alleviating a rear blind spot. Backup camera 37 can also include a wide-angle or fisheye lens. The many images captured by backup camera 37 can also be exhibited in the vehicle interior cabin by, for example, display 50 (discussed below).

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, and/or control input. Audio system 56 provides audio output to a vehicle occupant and can be a dedicated, stand-alone system or part of the primary vehicle audio system. According to one embodiment, audio system 56 is operatively coupled to both vehicle bus 58 and an entertainment bus (not shown) and can provide AM, FM and satellite radio, CD, DVD, and other multimedia functionality. This functionality can be provided in conjunction with or independent of an infotainment module. Microphone 54 provides audio input to the telematics unit 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 is preferably a graphics display and can be used to provide a multitude of input and output functions. Display 50 can be a touch screen on the instrument panel, a heads-up display reflected off of the windshield, a video projector that projects images onto the windshield from the vehicle cabin ceiling, or some other display. For example, display 50 can be the touch screen of the vehicle's infotainment module at the center console of the vehicle's interior. Various other vehicle-user interfaces can also be utilized, as the interfaces of FIG. 1 are only an example of one particular implementation.

### Method

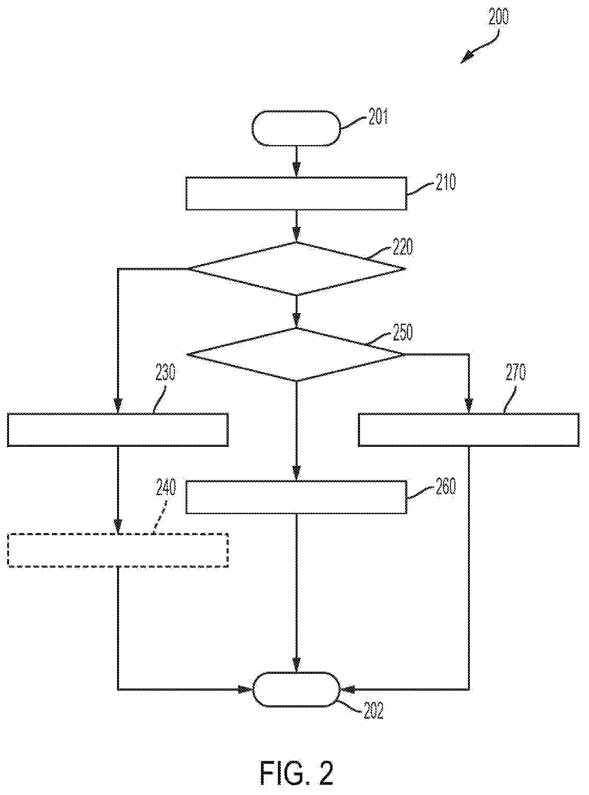

Turning now to FIG. 2, there is shown an embodiment of a method 200 to discern the distance to an object that would obstruct a liftgate 14 or a trunk door from properly swinging open. Method 200 can be applied to improve a vehicle's driving experience by increasing awareness of the surrounding vehicle environment as well as reducing the risk of damage to the vehicle 12 due to hitting the vehicle door against objects found in the vehicle environment (e.g., the area directly behind the vehicle). One or more aspects of indication method 200 may be carried out by telematics unit 30. For example, in order to carry out the one or more aspects of indication method, memory 38 includes executable instructions stored thereon and processor 36 executes these executable instructions. One or more ancillary aspects of method 200 may also be completed by one or more vehicle devices such as, for example, the one or more proximity sensors 31, backup camera 37, and display 50. One or more other ancillary aspects of method 200 may further be completed by liftgate 14 (or trunk door).

Method 200 begins at 201 in which vehicle 12 arrives at a parking location (e.g., a parking space in a parking lot or parking garage). In step 210, the vehicle 12 is placed in the reverse gear so as to back the vehicle 12 into the parking location. Moreover, in this step, the one or more proximity sensors 31, backup camera 37, and display 50 will be activated. As such, the proximity sensor(s) 31 will measure the horizontal distance to the closest object that can be found in the parking location (e.g., parking blocks, poles, walls, garage doors, loading docks, etc.). Backup camera 37 will capture one or more images of the environment behind the vehicle 12 (i.e., the parking location). Display 50 will also act to exhibit the images captured by the backup camera 37. Skilled artists will understand that the horizontal distance is the distance between two points along a substantially horizontal plane (i.e., a plane parallel to the horizon or parallel to a baseline). For example, the distance between the vehicle's rear bumper and an object resting on or erect from the ground.

In step 220, a value is retrieved for the minimum clearance needed to properly swing open the liftgate 14 while avoiding nearby objects, which may be based on the vehicle's make and model. This minimum horizontal distance clearance may also be established as the threshold value of Dₘᵢₙ (i.e., a first threshold value). It should be understood that the values of Dₘᵢₙ can be between approximately six (6) inches to thirty (30) inches. For example, the liftgate for a CHEVROLET™ TAHOE™ can extend approximately 23 inches from the vehicle's rear bumper. It should also be understood that Dₘᵢₙ can be stored in memory 38.

In this step, moreover, a value is retrieved that represents the necessary distance to properly swing the vehicle door open (e.g., liftgate or trunk door), so as to both avoid nearby objects as well as allow a person to stand behind the vehicle 12. This maximum clearance may also be established as the threshold value of Dₘₐₓ (i.e., a second threshold value). Moreover, Dₘₐₓ can be represented as Dₘₐₓ=Dₘᵢₙ+2.038 feet (or 24.456 inches). This equation is based on the fact that the average waistline of an North American male is approximately 3.261 feet (or 39.132 inches). It should also be understood that Dₘₐₓ is stored in memory 38.

Once the values for Dₘᵢₙ and Dₘₐₓ have been properly retrieved from memory 38, processor 36 will determine if the measured horizontal distance to nearest object is greater than or less than the threshold value of Dₘᵢₙ (first threshold value). If the value of the measured horizontal distance is less than the threshold value of Dₘᵢₙ, then method 200 will move to step 230. However, when the measured horizontal distance is greater than the threshold value of Dₘᵢₙ, method 200 will move to step 250.

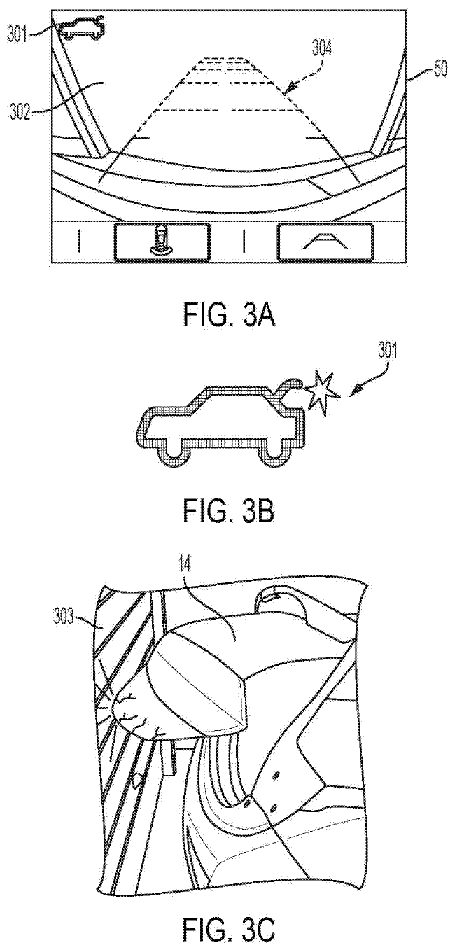

In step 230, with additional reference to FIGS. 3A through 3C, processor 36 will generate a high-risk indicator 301 that can be exhibited on display 50. This high-risk indicator 301 is designed to notify to a vehicle occupant (e.g., the driver or a passenger) that opening the liftgate 14 (or trunk door) will likely damage and/or scratch the door. Furthermore, the high-risk indicator 301 can be shown in a color associated with heightened risk—such as, for example, the color red. The high-risk indicator 301 can also be represented by a symbol that makes it clear to the driver that opening the liftgate 14 (or trunk door) will likely cause an unwanted impact between the door and an object 303 (shown as a garage door in the closed position). For example, the symbol can include an explosion emblem may be located near an open vehicle liftgate/trunk door, where the impact is likely to occur. As shown, the high-risk indicator 301 can be a graphical illustration generated onto the image feed 302 provided by the backup camera 37 and exhibited by display 50. The high-risk indicator 301 can also be presented on the upper left corner of this image feed 302 so as to avoid interfering with the backup trajectory graphical overlay lines 304, which are also generated onto the image feed 302 provided by the backup camera 37 and exhibited by display 50.

In optional step 240, processor 36 will disable the automatic vehicle door opening feature. This may be done, for example, by the processor 36 disabling the hydraulic system that forces the liftgate 14 to swing open in the upward direction. This may also be done, for example, by locking the liftgate 14 such that the hydraulic or electric systems cannot force the door open. Moreover, disabling this feature will prevent the liftgate 14 from likely colliding with the object 303. After optional step 240, method 200 moves to completion 202. It should be understood that, in certain embodiments, processor 36 would still allow for manual opening of the liftgate 14 so as to allow a vehicle occupant (e.g., the driver or a passenger) to appropriately discern any hazards that exist behind the rear of vehicle 12 and open the liftgate 14 to the extent that it is possible for them to reach into the rear cargo area and remove certain objects.

In step 250, processor 36 will determine if the measured horizontal distance to nearest object is greater than or less than the threshold value of Dₘₐₓ (second threshold value). If the value of the measured horizontal distance is less than the threshold value of Dₘₐₓ, then method 200 will move to step 260. However, when the measured horizontal distance is greater than the threshold value of Dₘₐₓ, method 200 will move to step 270.

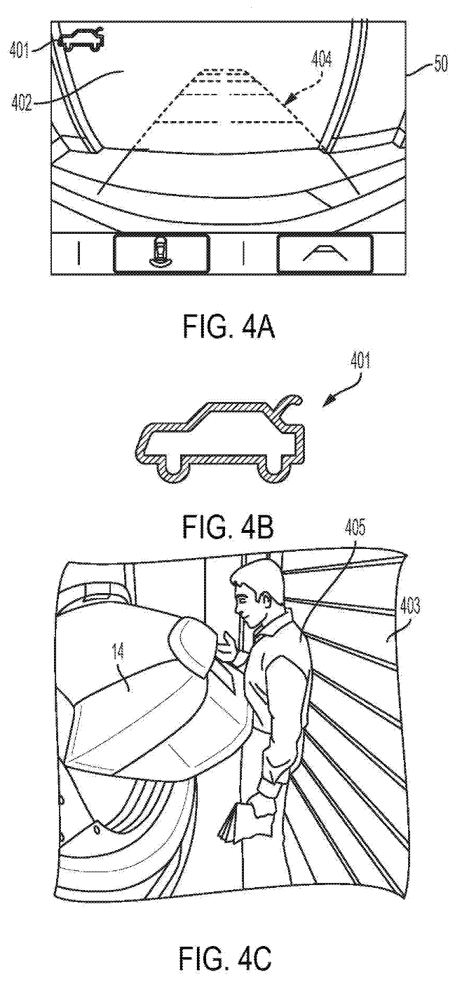

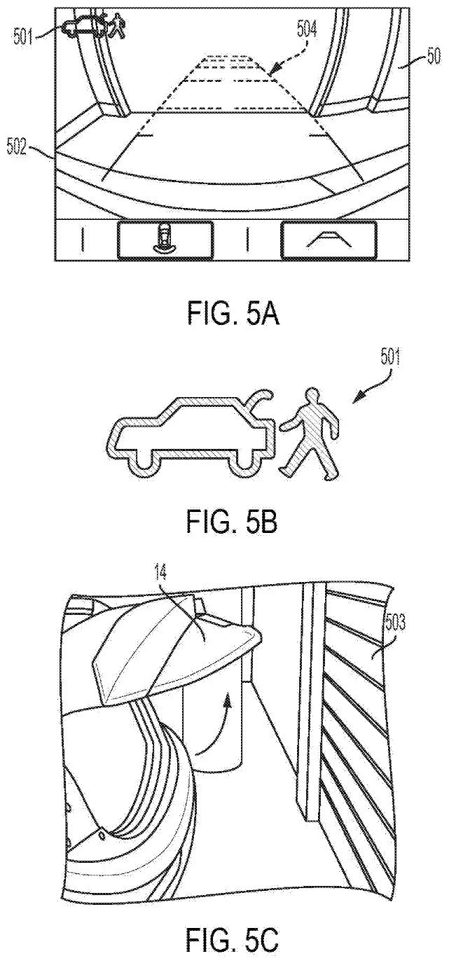

In step 260, with additional reference to FIGS. 4A through 4C, processor 36 will generate a medium-risk indicator 401 to be exhibited on display 50 when the measured horizontal distance is greater than the value of Dₘᵢₙ but less than the value of Dₘₐₓ. In other words, processor 36 will generate the medium-risk indicator 401 when the measured distance is considered large enough for the liftgate 14 to swing open without risk of collision but not so large as to allow an occupant 405 to easily and safely stand between the rear end of the vehicle 12 and the detected object 403. As follows, this medium-risk indicator 401 is designed to notify to the vehicle occupant that opening the liftgate 14 will be safe but there still won't be much room for someone to easily stand behind the vehicle 12.

The medium-risk indicator 401 can be shown in a color that will alert the vehicle occupant 405 to taking precautions or safety measures when attempting to access the rear cargo area—such as, for example, the color yellow. The medium-risk indicator 401 can also be represented by a symbol that makes it clear to the driver that opening the liftgate 14 should be free from unwanted impact between the door and an object 403 (e.g., a closed garage door) but standing behind the vehicle will be too tight for comfort. For example, the symbol can be a vehicle 12 with an open vehicle liftgate/trunk door 14 but excluding a person being behind the open liftgate/trunk door 14. Similar to the high-risk indicator 301, discussed above, the medium-risk indicator 401 can be a graphical illustration generated onto the image feed 402 provided by the backup camera 37 and exhibited by display 50. The medium-risk indicator 401 can also be presented on the upper left corner of this image feed 402 so as to avoid interfering with the backup trajectory graphical overlay lines 404, which are also generated onto the image feed 402 provided by the backup camera 37 and exhibited by display 50. After step 260, method 200 moves to completion 202.

In step 270, with additional reference to FIGS. 5A through 5C, processor 36 will generate a low-risk indicator 501 to be exhibited on display 50 when the measured horizontal distance is greater than the value of Dₘₐₓ. In other words, processor 36 will generate the low-risk indicator 501 when the measured distance is considered large enough for the liftgate to swing open without risk of collision as there should be enough room to allow a person to easily and safely stand between the rear end of the vehicle 12 and the detected object 503. As follows, this low-risk indicator 501 is designed to notify to the vehicle occupant that opening the liftgate 14 will be safe and they can easily and safely stand behind the vehicle 12.

The low-risk indicator 501 can be shown in a color that will notify the vehicle occupant that they can freely access the rear cargo area of the vehicle—such as, for example, the color green. The low-risk indicator 501 can also be represented by a symbol that makes it clear to the driver that opening the liftgate 14 should be free from unwanted impact between the door and an object 503 (e.g., a closed garage door) and that there is plenty of room for someone to stand behind the vehicle and access the rear cargo area. For example, the symbol can be a vehicle 12 with an open vehicle liftgate/trunk door 14 and showing a human silhouette that can be accessing the cargo area or trunk of the vehicle. Similar to the high-risk indicator 301 and medium risk indicator 401, discussed above, the low-risk indicator 501 can be a graphical illustration generated onto the image feed 502 provided by the backup camera 37 and exhibited by display 50. The low-risk indicator 501 can also be presented on the upper left corner of this image feed 502 so as to avoid interfering with the backup trajectory graphical overlay lines 504, which are also generated onto the image feed 502 provided by the backup camera 37 and exhibited by display 50. After step 270, method 200 moves to completion 202.

As can be understood, these indicators 301, 401, 501 are innovative improvements to the user interface provided by display 50 while backing their vehicle into a parking space. In addition, these indicators 301, 401, 501 innovatively provide a vehicle occupant with an understanding of how much space they'll have behind their vehicle after they've parked. Moreover, these indicators 301, 401, 501 practically provide this insight while using a minimal amount of space on the vehicle backup user interface (i.e., to allow for there to be ample room on the screen for the video feed of the backup camera). It should also be understood that one or more of these indicators 301, 401, 501 could be supported by an additional notification feature. For example, when either the medium-risk indicator 401 or high-risk indicator 501 are triggered, processor 36 could also generate an audio notification (e.g., a chime alert delivered from audio system 56), generate a haptic notification (e.g., generating piezoelectric vibrations from within at least a portion of the vehicle occupant's seat), and/or activating a double pull door handle feature (e.g., one pull of the door handle unlocks the door and the second pull allows the vehicle occupant to egress from the vehicle's cabin).

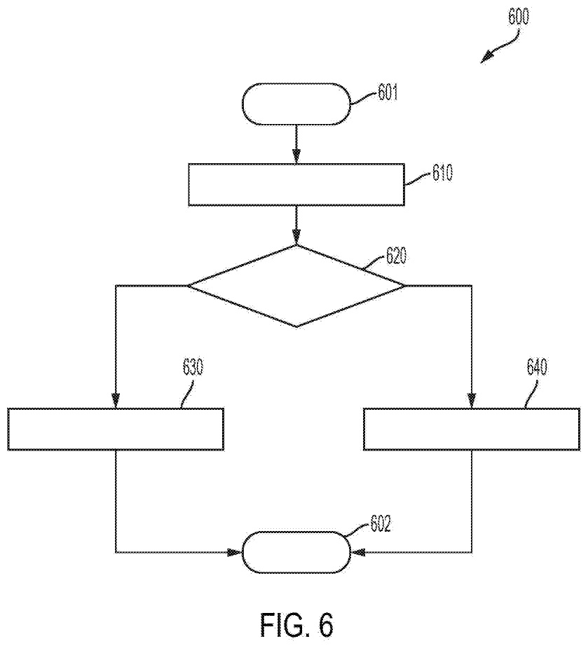

Turning now to FIG. 6, there is shown an embodiment of a method 600 to disable a liftgate 14 or a trunk door from fully swinging open when a low hanging surface in the vehicle environment would obstruct the liftgate's 14 (or trunk door's) full range of motion. One or more aspects of indication method 200 may be carried out by telematics unit 30. For example, in order to carry out the one or more aspects of indication method, memory 38 includes executable instructions stored thereon and processor 36 executes these executable instructions. One or more ancillary aspects of method 200 may also be completed by one or more vehicle devices such as, for example, the one or more proximity sensors 31 and BCM 24. One or more other ancillary aspects of method 200 may further be completed by liftgate 14.

Method 600 begins at 601 in which vehicle 12 arrives at a parking location (e.g., a parking space in a parking lot or parking garage). In step 610, the vehicle 12 is placed in the reverse gear so as to back the vehicle 12 into the parking location. Moreover, in this step, the one or more proximity sensors 31 are activated. As such, the proximity sensor(s) 31 will measure the vertical distance to the closest surface that can be found in the parking location (e.g., ceilings, hanging plants, ledges, tree branches, stalagmites, etc.). The vertical distance can also be measured at the same time the one or more proximity sensors 31 measure the horizontal distance to any objects (see Step 220 of method 200, above). Skilled artists will understand that the vertical distance (otherwise known as the “up” distance) is the altitude of an object or location and could be thought of as the distance between two points along a vertical plane. For example, the distance between the roof of a vehicle and a ceiling in a parking ramp.

In step 620, a value is retrieved for the minimum clearance height needed to properly swing the liftgate 14 upwardly while avoiding nearby surfaces, which may be based on the vehicle's make and model. This minimum vertical distance clearance (altitudinal clearance) may also be established as the threshold value of DVₘᵢₙ (i.e., a third threshold value). It should be understood that the values of DVₘᵢₙ can be between approximately five and a half (5½) feet to seven (7) feet, depending on the vehicle's make and model.

Once the value for DVₘᵢₙ has been properly retrieved from memory 38, processor 36 will determine if the measured vertical distance to nearest object is greater than or less than the threshold value of DVₘᵢₙ (third threshold value). If the value of the measured vertical distance is less than the threshold value of DVₘᵢₙ, then method 600 will move to step 630. However, when the measured horizontal distance is greater than the threshold value of DVₘᵢₙ, method 600 will move to step 640.

In step 630, processor 36 will disable the automatic vehicle door opening feature. This may be done, for example, by the processor 36 disabling the hydraulic system that forces the liftgate 14 to swing open in the upward direction. This may also be done, for example, by locking the liftgate 14 such that the hydraulic or electric systems cannot force the door open. Moreover, disabling this feature will prevent the door from being able to collide with the surface (e.g., parking space ceiling). It should be understood the automatic vehicle door opening feature may be disabled mid-swing of the liftgate 14 so as to stop if from opening any further. After step 630, method 600 moves to completion 602. In step 640, however, processor 36 will allow the automatic vehicle door opening feature to fully swing the liftgate 14 open in the upward direction.

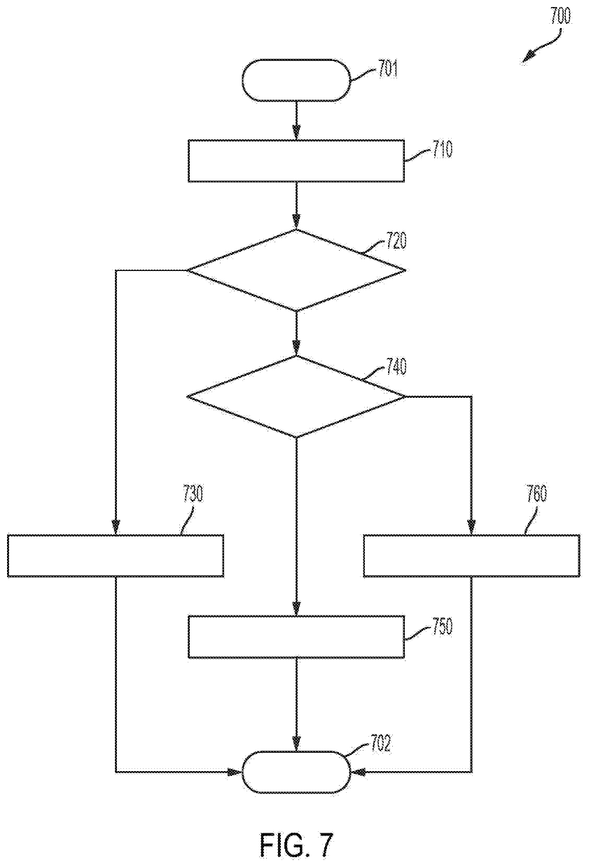

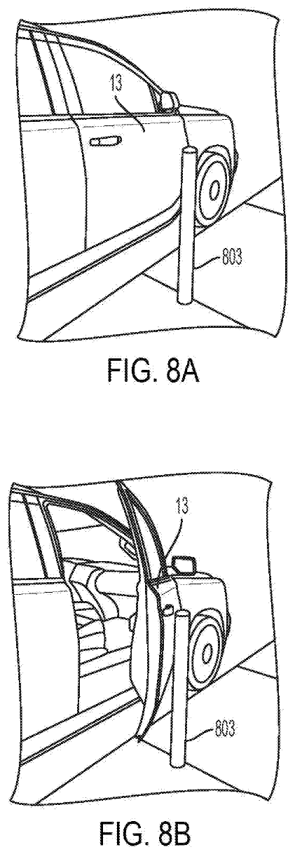

Turning now to FIG. 7, there is shown an embodiment of a method 700 to discern the distance to an object that would obstruct a vehicle occupant door 13 from properly swinging open. Method 700 can be applied to improve a vehicle's driving experience by increasing awareness of the surrounding vehicle environment as well as reducing the risk of damage to the vehicle 12 due to hitting the vehicle door 13 against objects. One or more aspects of indication method 700 may be carried out by telematics unit 30. For example, in order to carry out the one or more aspects of indication method, memory 38 includes executable instructions stored thereon and processor 36 executes these executable instructions. One or more ancillary aspects of method 700 may also be completed by one or more vehicle devices such as, for example, the one or more proximity sensors 31 and display 50. One or more other ancillary aspects of method 700 may further be completed by one of the vehicle occupant doors 13.

Method 700 begins at 701 in which vehicle 12 arrives at a parking location (e.g., a parking space in a parking lot or parking garage). In step 710, the vehicle 12 may be placed in the parked gear. Moreover, in this step, the one or more proximity sensors 31 and display 50 will be activated. As such, the proximity sensor(s) 31 will measure the horizontal distance to the closest object that can be found in the parking location (e.g., neighboring vehicles, parking blocks, poles, walls, loading docks, etc.). Display 50 will also act to exhibit a user interface that represents the environment surrounding the vehicle 12.

In step 720, processor 36 retrieves a value for the minimum horizontal distance clearance needed to swing the vehicle occupant door 13 open while avoiding nearby objects, which may be based on the vehicle's make and model. This minimum clearance may also be established as the threshold value of Dₘᵢₙ (i.e., a first threshold value). It should be understood that the values of Dₘᵢₙ can be between approximately 18 inches to 24 inches.

In this step, moreover, a value is retrieved for the necessary distance to fully swing the vehicle occupant door 13 open so as to both avoid nearby objects as well as allow a full range of motion so that a person can easily egress from their vehicle. This maximum clearance may also be established as the threshold value of Dₘₐₓ (i.e., a second threshold value). Moreover, Dₘₐₓ can be represented as Dₘₐₓ=Dₘᵢₙ+1 foot. This equation is based on the fact that the average door swing for the vehicle operator and passenger doors is between approximately three (3) feet to four (4) feet.

Once the values for Dₘᵢₙ and Dₘₐₓ have been properly retrieved from memory 38, processor 36 will determine if the measured horizontal distance to nearest object is greater than or less than the threshold value of limn (first threshold value). If the value of the measured horizontal distance is less than the threshold value of Dₘᵢₙ, then method 700 will move to step 730. However, when the measured horizontal distance is greater than the threshold value of Dₘᵢₙ, method 700 will move to step 740.

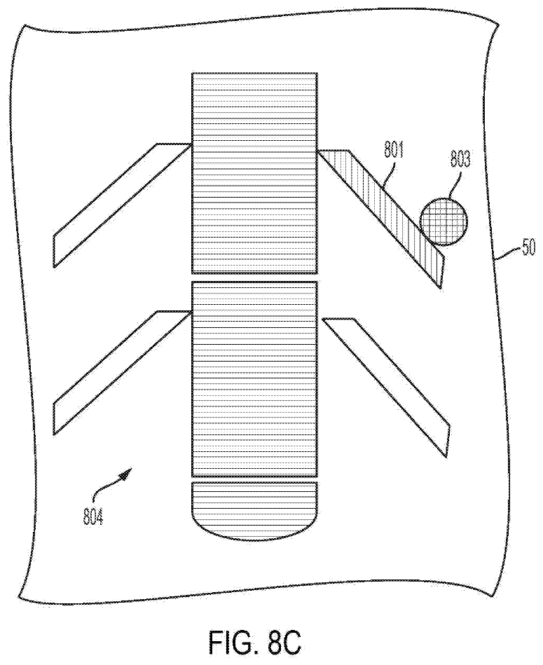

In step 730, with additional reference to FIGS. 8A through 8C, processor 36 will generate a high-risk indicator 801 that can be exhibited on display 50. This high-risk indicator 801 is designed to notify to a vehicle occupant (e.g., the driver or a passenger) that trying to swing the vehicle occupant door 13 open will likely damage or at least scratch the door. Furthermore, the high-risk indicator 801 can be shown in a color associated with heightened risk—such as, for example, the color red. The high-risk indicator 801 can also be represented by a symbol that makes it clear to the driver that opening the vehicle occupant door 13 will likely cause an unwanted impact between the door and an object 803 (shown as a pole erect from the ground). As shown, the high-risk indicator 801 can be a graphical illustration generated onto a user interface 804 exhibited by display 50, which symbolizes and can make it clear that opening vehicle occupant door 13 will likely cause an unwanted impact with an object 803. After step 730, method 700 moves to completion 702.

In step 740, processor 36 will determine if the measured horizontal distance to nearest object is greater than or less than the threshold value of Dₘₐₓ (second threshold value). If the value of the measured horizontal distance is less than the threshold value of Dₘₐₓ, then method 700 will move to step 750. However, when the measured horizontal distance is greater than the threshold value of Dₘₐₓ, method 700 will move to step 760.

In step 750, processor 36 will generate a medium-risk indicator (similar to that of the indicator shown in FIG. 8C) to be exhibited on display 50 when the measured horizontal distance is greater than the value of Dₘᵢₙ but less than the value of Dₘₐₓ. In other words, processor 36 will generate the medium-risk indicator when the measured distance is considered large enough for the vehicle door to swing open so as to allow one to get out of the vehicle but not so large so as to allow the door to fully swing open so as to exhaust its full range of motion. As follows, this medium-risk indicator is designed to notify to a vehicle occupant that they should take caution when opening the vehicle door and make sure they don't pivot the door open so far that it will collide with a nearby object 803. Moreover, this medium-risk indicator is designed to notify to the vehicle occupant that they should take caution when getting out of the vehicle because there won't be much room to get out of the vehicle 12.

The medium-risk indicator can be shown in a color that will alert the vehicle occupant to taking precautions when opening the door and getting out of the vehicle—such as, for example, the color yellow. The medium-risk indicator can also be represented by a symbol that makes it clear to the driver that opening the vehicle door 13 should be free from unwanted impact when they're being careful but space to get out of the vehicle will also be tight. Similar to the high-risk indicator 801, discussed above, the medium-risk indicator can be a can be a graphical illustration generated onto a user interface 804 exhibited by display 50. After step 750, method 700 moves to completion 702.

In step 760, processor 36 will generate a low-risk indicator to be exhibited on display 50 when the measured horizontal distance is greater than the value of Dₘₐₓ (similar to that of the indicator shown in FIG. 8C—but may also exclude any object symbols 803 being shown in proximity to the opened door). In other words, processor 36 will generate the low-risk indicator when the measured distance is considered large enough for the vehicle door fully to swing open without risk of colliding into any nearby objects. As follows, this low-risk indicator is designed to notify to the vehicle occupant that opening the vehicle occupant door 13 will be safe and they can easily and safely egress from the vehicle 12.

The low-risk indicator can be shown in a color that will notify the vehicle occupant that they can freely swing their door open and easily get out of the vehicle—such as, for example, the color green. The low-risk indicator can also be represented by a symbol that makes it clear to the driver that opening the vehicle occupant door 13 should be free from unwanted impact between the door and an object 803 (e.g., a pole) and that there is plenty of room for someone to get out of the vehicle cabin. After step 760, method 700 moves to completion 702.

As can be understood, these vehicle side door 13 indicators are innovative improvements to the user interface provided by display 50 while parking their vehicle. These indicators also innovatively provide a vehicle occupant with an understanding of how much space they'll have open their door after they've parked. These indicators practically provide this insight while using a minimal amount of space on the vehicle backup user interface. It should also be understood that one or more of these indicators could be supported by an additional notification feature, as discussed above.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A method to indicate the space available to open a vehicle door, the method comprising:
sensing, via a processor, a horizontal distance between the vehicle door and an object in an environment surrounding a vehicle;
determining, via the processor, if the horizontal distance is greater than or less than a first threshold value;
determining, via the processor, if the horizontal distance is greater than or less than a second threshold value; and
providing, via the processor, an indicator based on the determination of whether the horizontal distance is greater than or less than the first threshold value and the determination of whether the horizontal distance is greater than or less than the second threshold value.

2. The method of claim 1, wherein:
the indicator can be provided as a low-risk indicator, medium-risk indicator, or high-risk indicator;
wherein the high-risk indicator is provided when the processor determines that the horizontal distance is less than the first threshold value;
wherein the medium-risk indicator is provided when the processor determines that the horizontal distance is greater than the first threshold value and less than the second threshold value; and
wherein the low-risk indicator is provided when the processor determines that the horizontal distance is greater than the second threshold value.

3. The method of claim 2, further comprising:
disabling, via the processor, an automatic vehicle door opening function when the processor determines that the horizontal distance is less than the first threshold value.

4. The method of claim 1, further comprising:
sensing, via the processor, a vertical distance between the vehicle door and a surface in the environment surrounding the vehicle;
determining, via the processor, if the vertical distance is greater than or less than a third threshold value; and
disabling, via the processor, an automatic vehicle door opening function when the processor determines that the vertical distance is less than the third threshold value.

5. The method of claim 1, wherein the indicator is provided by being exhibited on a display located in the vehicle.

6. The method of claim 1, wherein the vehicle door is a liftgate and wherein the indicator is configured to provide a vehicle occupant with an understanding of an amount of space located between the liftgate and the object in the environment surrounding the vehicle.

7. The method of claim 1, wherein the vehicle door is an occupant door and wherein the indicator is configured to provide a vehicle occupant with an understanding of an amount of space located between the occupant door and the object in the environment surrounding the vehicle.

8. A system to indicate the space available to open a vehicle door, the system comprising:
a memory configured to comprise one or more executable instructions and a processor configured to execute the executable instructions, wherein the executable instructions enable the processor to carry out the following steps:
sensing a horizontal distance between the vehicle door and an object in an environment surrounding a vehicle;
determining if the horizontal distance is greater than or less than a first threshold value;
determining if the horizontal distance is greater than or less than a second threshold value; and
providing an indicator based on the determination of whether the horizontal distance is greater than or less than the first threshold value and the determination of whether the horizontal distance is greater than or less than the second threshold value.

9. The system of claim 8, wherein:
the indicator can be provided as a low-risk indicator, medium-risk indicator, or high-risk indicator;
wherein the high-risk indicator is provided when the processor determines that the horizontal distance is less than the first threshold value;
wherein the medium-risk indicator is provided when the processor determines that the horizontal distance is greater than the first threshold value and less than the second threshold value; and
wherein the low-risk indicator is provided when the processor determines that the horizontal distance is greater than the second threshold value.

10. The system of claim 9, wherein the executable instructions enable the processor to carryout the following steps:
disabling an automatic vehicle door opening function when the processor determines that the horizontal distance is less than the first threshold value.

11. The system of claim 8, wherein the executable instructions enable the processor to carryout the following steps:
sensing a vertical distance between the vehicle door and a surface in the environment surrounding the vehicle;
determining if the vertical distance is greater than or less than a third threshold value; and
disabling an automatic vehicle door opening function when the processor determines that the vertical distance is less than the third threshold value.

12. The system of claim 8, wherein the indicator is provided by being exhibited on a display located in the vehicle.

13. The system of claim 8, wherein the vehicle door is a liftgate and wherein the indicator is configured to provide a vehicle occupant with an understanding of an amount of space located between the liftgate and the object in the environment surrounding the vehicle.

14. The system of claim 8, wherein the vehicle door is an occupant door and wherein the indicator is configured to provide a vehicle occupant with an understanding of an amount of space located between the occupant door and the object in the environment surrounding the vehicle.

15. A non-transitory and machine-readable medium having stored thereon executable instructions adapted to indicate the space available to open a vehicle door, which when provided to a processor and executed thereby, causes the processor to carry out the following steps:
sensing a horizontal distance between the vehicle door and an object in an environment surrounding a vehicle;
determining if the horizontal distance is greater than or less than a first threshold value;
determining if the horizontal distance is greater than or less than a second threshold value; and
providing an indicator based on the determination of whether the horizontal distance is greater than or less than the first threshold value and the determination of whether the horizontal distance is greater than or less than the second threshold value.

16. The non-transitory and machine-readable memory of claim 15, wherein:
the indicator can be provided as a low-risk indicator, medium-risk indicator, or high-risk indicator;
wherein the high-risk indicator is provided when the processor determines that the horizontal distance is less than the first threshold value;
wherein the medium-risk indicator is provided when the processor determines that the horizontal distance is greater than the first threshold value and less than the second threshold value; and
wherein the low-risk indicator is provided when the processor determines that the horizontal distance is greater than the second threshold value.

17. The non-transitory and machine-readable memory of claim 15, wherein the executable instructions enable the processor to carryout an additional step of disabling an automatic vehicle door opening function when the processor determines that the horizontal distance is less than the first threshold value.

18. The non-transitory and machine-readable memory of claim 15, wherein the executable instructions enable the processor to carryout the following additional steps:
sensing a vertical distance between the vehicle door and a surface in the environment surrounding the vehicle;
determining if the vertical distance is greater than or less than a third threshold value; and
disabling an automatic vehicle door opening function when the processor determines that the vertical distance is less than the third threshold value.

19. The non-transitory and machine-readable memory of claim 15, wherein the indicator is provided by being exhibited on a display located in the vehicle.

20. The non-transitory and machine-readable memory of claim 15, wherein the vehicle door is a liftgate and wherein the indicator is configured to provide a vehicle occupant with an understanding of an amount of space located between the liftgate and the object in the environment surrounding the vehicle.
